(19) United States
(12) Patent Application Publication
(10) Pub. No.: US 2002/0110401 A1
(43) Pub. Date: Aug. 15, 2002

(54) Keyboard and associated display

(76) Inventor: Daniel B. Gershuni, Zichron Yaakov (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(21) Appl. No.: 09/887,255

(22) Filed: Jun. 25, 2001

Related U.S. Application Data
(60) Provisional application No. 60/268,707, filed on Feb. 15, 2001.

(51) Int. Cl. B41J 29/18

(52) U.S. Cl. 400/703; 400/472

(57) ABSTRACT

A typing aid comprising a keyboard and an auxiliary or integrated display screen deployed in close proximity to or within the keyboard, designed to assist the non-touch typist to enter text data into a computing device with a minimum of or no head and neck movements between keyboard and display screen. Also provided is a method of entering text data into a computing device using the typing aid and a means for allowing the auxiliary display screen to follow the current cursor position for document editing.

### CROSS-REFERENCE TO RELATED APPLICATIONS

The Present application claims priority from U.S. Provisional Patent Application No. 60/268707, filed Feb. 15, 2001.

### FIELD AND BACKGROUND OF THE INVENTION

The present invention relates to the field of data input devices and, more particularly but not exclusively, to a keyboard with an associated display.

Today, the dominant tool of choice for many home and office tasks that include composing documents, e-mailing, web browsing and data entry into spreadsheets or databases is the personal computer (PC), both stationary desktop models and portable laptop models. The typical PC used to perform these tasks comprises an input device consisting of a keyboard and an output device consisting of a monitor with a display screen.

The user inputs data to a desktop PC by typing at a keyboard that typically sits in front of and slightly below the level of the display screen. This ergonomic configuration has existed since the earliest times of computing with large mainframe computer systems. The users of such mainframes sat at terminals composed of monitors and keyboards remote from the mainframe itself. This terminal model has become the de facto standard for inputting and outputting with the modern PC.

Other typing/composing tools, functionally more limited in scope than the modern PC, such as the typewriter and the word processor, addressed the input/output issue in different ways. The earliest typewriter consisted simply of a machine with a set of keys which activated a mechanical printing mechanism. Later typewriters had keys which activated an electronically driven printer. Improvements to the later typewriters included a small character display which allowed the user to review the typing before committing the text to print. U.S. Pat. No. 4,323,315 assigned to Ing. C. Olivetti & C.,S.p.A., which produces Olivetti typewriters, discloses a typewriter with a small integral display that allows a user to view the last data entered. Thereafter, the IBM Wheelwriter 5000 added a small monitor to the typewriter allowing a user to review a larger amount of typing, and even allow copy and paste functionality to the typing process. This external monitor was deployed on an arm positioning the monitor a short distance above the keyboard. The next development was to incorporate the typewriter function of document production into a computer by typing at the keyboard and displaying the typed text on the display screen. Word processing capability, using the power of the computer's processor, followed immediately thereafter. The present state of the art includes numerous word processing programs capable of assisting typists in every way imaginable to produce complex documents quickly and effortlessly on a desktop or laptop PC.

However, one aspect of document production has become problematic following the incorporation of the PC into the document production process. When typing on a keyboard and displaying the typed text on a remote display screen, it is necessary for a typist to divert her eyes from the keyboard to the display in order to review the typed text. This presents no problem for the accomplished touch typist who can scan the display while continuing to type. However, the less capable typist must look at the keyboard while typing and is thus unable to continue typing while reviewing the previously typed text. Accordingly, she is required to stop typing, look at the display and look back to the keyboard in order to edit the text or to resume typing. Typing studies have shown that low level typists type in short bursts, usually between one and four words and then pause to review and correct the typing. This frequent and ongoing need to shift the eyes, including moving the head and neck, is inefficient and time consuming, resulting in reduced productivity. For the less than expert typist, this requirement is a cause of slowness, frequent mistakes and often frustration.

Moreover, this repeated activity is physically demanding on the cervical vertebral column and has become recognized as a cause of fatigue and repetitive stress injury of the administrative workforce. For the less than expert typist, this requirement is a cause of slowness, inefficiency, frequent mistakes and often frustration.

### SUMMARY OF THE INVENTION

It is thus an object of the present invention to solve the above problems. There is thus provided a way to integrate the input function of the keyboard with the output function of the display screen in such a manner that a typist is not required to move her head and neck when transferring between typing and reviewing text.

According to an aspect of the present invention there is provided a keyboard with associated display. One of the advantages of having a display, preferably a diminutive of the main computer display, associated with the keyboard is to assist the non-touch typist to enter text data via the keyboard which she is able to review with a minimum of head and neck movements.

Accordingly, it is an object of the present invention to provide a typing aid that places a display screen within the same field of view as an associated keyboard thereby to allow a typist to view both the typing keys and the typed text without substantially moving the head and neck.

It is a further object of the present invention to provide a typing aid that visually integrates the input and output interfaces of a computing device to aid in the editing of data stored in the memory of the computing device.

According to one aspect of the present invention there is provided a typing aid which includes a keyboard and a current data screen for assisting with user data input to a computing device. The typing aid comprises functionality for interacting with the computing device to display data associated with a current data input position on the current data screen. The current data input position includes newly generated data input via the keyboard and data stored in a memory of the computing device. The keyboard and the current data screen are located together in a single user field of view thereby enabling a user to simultaneously see the keyboard and the data associated with a current data input position.

According to another aspect of the present invention there is provided a typing aid consisting of a computing device capable of generating data which comprises a computer having a monitor, a keyboard connected thereto and a current data screen, the computing device comprising functionality for displaying data associated with a current data input position on the current data screen. The keyboard and the current data screen are located together in a single user field of view thereby enabling a user to simultaneously see the keyboard and the data associated with a current data input position.

According to another aspect of the present invention there is provided a method of assisting with user data input to a computing device comprising the steps of

a. interrogating an operating system of the computing device regarding a location of a current data input position;

b. identifying, from the interrogation, data associated with the current data input position which includes at least one of newly generated data input via a keyboard and data stored in a memory of the computing device;

c. sending the identified data to an output associated with the keyboard; and

d. displaying the identified data on a current data screen which is located together with the keyboard in a single user field of view such as to allow simultaneous viewing by a user of the current data screen and the keyboard.

According to features in the described preferred embodiments the typing aid further comprises functionality for directly displaying, on the current data screen, newly generated data input via the keyboard thereby enabling a user to simultaneously see the keyboard and the newly generated data input via the keyboard. According to features in the described preferred embodiments the typing aid further comprises functionality for editing the data associated with a current data position.

According to features in the described preferred embodiments the current data screen is integral to the keyboard.

According to features in the described preferred embodiments the current data screen is removably attachable to the keyboard.

According to features in the described preferred embodiments the current data screen is an LCD screen.

According to features in the described preferred embodiments the current data screen is powered from the computing device.

According to features in the described preferred embodiments the current data screen is powered by its own independent power supply.

According to features in the described preferred embodiments the data associated with the current data input position is at least part of a text document or, alternatively, any program having text data input.

According to features in the described preferred embodiments the current data screen is capable of showing a single line of text.

According to features in the described preferred embodiments the current data input position is indicated by the presence thereat of a cursor.

According to features in the described preferred embodiments the data associated with the current data input position comprises the text preceding the cursor.

According to features in the described preferred embodiments the data associated with the current data input position comprises the text following the cursor.

According to features in the described preferred embodiments the data associated with the current data input position comprises text preceding the cursor and text following the cursor.

According to features in the described preferred embodiments the cursor is at the beginning of a text document.

According to features in the described preferred embodiments the cursor is at the end of a text document.

According to features in the described preferred embodiments the cursor is substantially in the middle of a text document.

According to features in the described preferred embodiments the cursor is capable of moving around within a text document thereby changing the display on the current data screen.

According to features in the described preferred embodiments the cursor is capable of moving between different text documents thereby changing the display on the current data screen.

According to features in the described preferred embodiments the cursor is capable of moving between different software applications thereby changing the display on the current data screen.

The present invention successfully addresses the shortcomings of the presently known configurations by providing a typing aid designed to assist the non-touch typist to enter text data via a keyboard with reduced head and neck movements.

The term “cursor”, as used in the present description with claims, includes a current data input position however indicated or even if not indicated to a user.

### BRIEF DESCRIPTION OF THE DRAWINGS

With specific reference now to the drawings in detail, it is stressed that the particulars shown are by way of example and for the purposes of illustrative discussion of the preferred embodiment of the present invention only, and are presented to provide what is believed to be the most useful and readily understood description of the principles and conceptual aspects of the invention. In this regard, no attempt is made to show structural details of the invention in more detail than is necessary for a fundamental understanding of the invention. The description taken with the drawings makes apparent to those skilled in the art how the several forms of the invention may be embodied in practice.

In the drawings:

FIG. 1 is a schematic illustration of a typing aid constructed in accordance with a preferred embodiment of the present invention deployed with respect to a computing device;

FIG. 2 is a schematic illustration of a hardwired keyboard with an integral current data screen in accordance with a preferred embodiment of the typing aid of FIG. 1;

FIG. 3 is a schematic illustration of a hardwired keyboard with a current data screen removably attached thereto in accordance with a preferred embodiment of the typing aid of FIG. 1;

FIG. 4 is a schematic illustration of a wireless keyboard with a current data screen removably attached thereto in accordance with a preferred embodiment of the typing aid of FIG. 1; and

FIG. 5 is a black box diagram of the software configuration in accordance with a preferred embodiment of the typing aid of FIG. 1.

### DESCRIPTION OF THE PREFERRED EMBODIMENTS

Before explaining at least one embodiment of the invention in detail, it is to be understood that the invention is not limited in this application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The principles and operation of a typing aid according to the present invention may be better understood with reference to the drawings and accompanying descriptions.

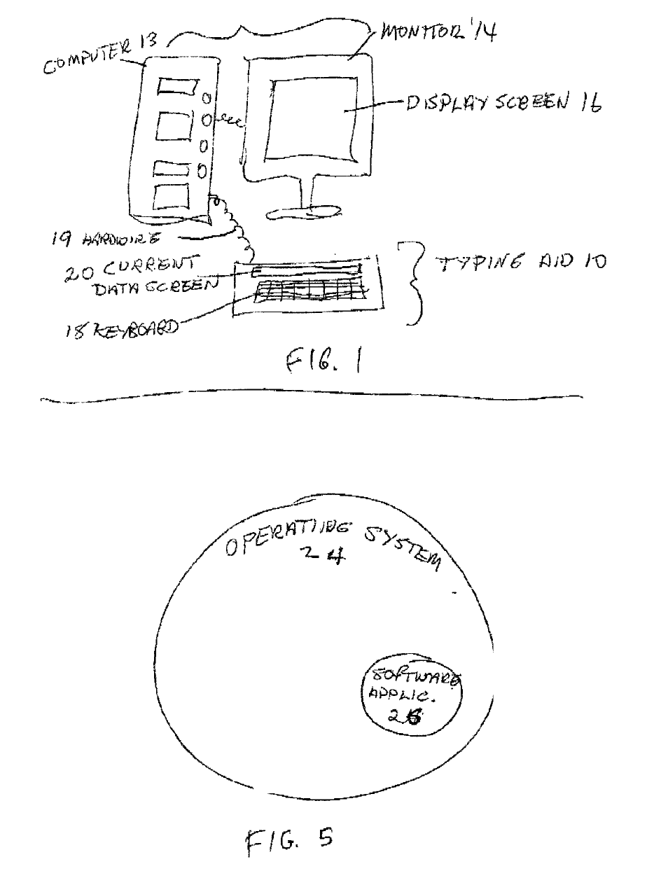

Reference is now made to FIG. 1 which shows a typing aid constructed in accordance with a preferred embodiment of the present invention which is referred to hereinbelow as typing aid 10. Typing aid 10 is deployed with respect to a computing device which consists of a computer 13, a monitor 14 bearing display screen 16 and other standard computing peripherals. The skilled reader will be aware of variations of this standard arrangement such as computers not having a separate tower and display, for example, the typical “Mac” configuration, and computers which are portable and self contained, such as laptops. It will be appreciated that embodiments of typing aid 10 may preferably be constructed so as to be compatible with all such configurations.

Typing aid 10 preferably comprises a keyboard 18 associated with current data screen 20, and may be considered as part of the computing device. Typing aid 10 is an aid to typists, but is preferably not part of a word processing program or system installed within computer 13. Rather, it is a separate application, consisting of hardware and software, that is usable by a user who types at computer 13, which may or may not support a word processing program, to facilitate the entry of text data into an application. It is useful with respect to computer 13 irrespective of the existence of a word processing program or of the application in use. Typing aid 10 is preferably designed and configured to be compatible with any data entry environment that requires the entry of text data via a keyboard which produces a visual display.

Typing aid 10 is not an electric typewriter although its appearance is similar to electronic typewriters which have data displays integrated therein.

Current data screen 20 displays data associated with the current typing position in very close proximity to keyboard 18 on which such data is being entered. This proximal arrangement of input interface and output interface permits a typist to simultaneously see keyboard 18 and the data being entered as a result of her strokes upon keyboard 18. It is easily appreciated that such an arrangement reduces the need for shifting the gaze from keyboard 18 to display screen 16.

The field of typing instruction provides guidance with respect to the common practices of typists. A less skilled typist will exhibit certain common behaviors.

1. She will keep her head pointed down and squarely at the keyboard while she types.

2. She will type “bytes” or bursts of information ranging from one to four words at a time.

3. She will raise her head up to the monitor in order to find the blinking cursor to review the most recently typed data.

4. If a mistake is found, she will lower her head to the keyboard and locate either the backspace key or the arrow keys.

5. Keeping her finger on the necessary key (either backspace or arrow), she will raise her head back up to the monitor and tap the key until either the text has been deleted or the cursor is in the correct position.

6. She will, thereafter, lower her head back down to the keyboard and type the necessary correction.

7. Having made the modification, she will raise her head back up to the monitor, review the text and, if problem-free, lower her head again and recommence typing.

This seven step process repeats itself every few words throughout the duration of typing.

This process, is grossly inefficient, time consuming and unenjoyable. It causes slowness of data entry and requires that a substantial amount of time be devoted to error correction. Moreover, it is physically demanding on the typist's neck and eyes, requiring repeated flexion and extension of the cervical structure.

Accordingly, typing aid 10 is properly described primarily as an aid for typing efficiency, and secondarily as a device which provides orthopaedic and ophthalmologic benefits. The use of typing aid 10 reduces head and neck movement in the course of typing, thereby reducing or preventing cervical muscle fatigue and repetitive stress injury to neck ligaments and tendons. Additional benefits include reducing or preventing other orthopaedic conditions associated with typing, including Carpal Tunnel Syndrome and Repetitive Stress Injury of the elbow, forearm, wrist and fingers. Moreover, typing aid 10 provides ophthalmologic benefit by reducing the likelihood of eye strain. Eye strain is often caused by continuous and repetitive shifting of focus from an object closer to an object farther from the viewer. Such shifting of focus requires the ciliary eye muscles to repeatedly contract and relax to change the focal length of the lens of the eye, resulting in eye muscle fatigue, commonly known as eye stain.

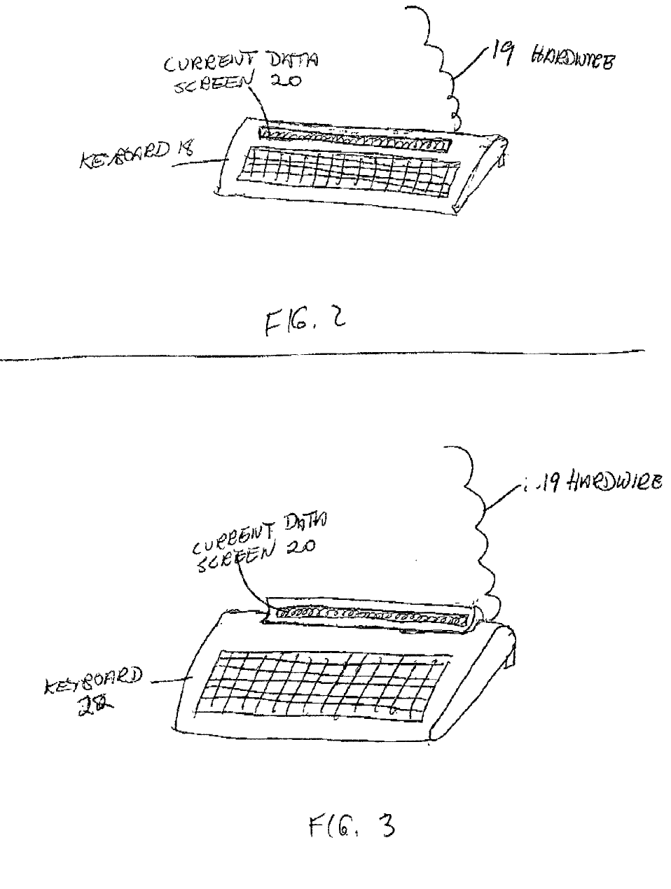

Reference is now made to FIG. 2 which shows current data screen 20 as an integral element of keyboard 18, which is a conventionally hardwired keyboard which communicates with computer 13 via hardwire 19. Current data screen 20 is so named because it is preferably limited to displaying the data associated with the current typing position. In other words, it displays a predetermined quantity of the most recently typed characters or the characters associated with the current position of the cursor.

It will be appreciated that current data screen 20 may be incorporated into any size, shape or type of keyboard, including ergonomic keyboards, sectional keyboards and even virtual keyboards, in which case current data screen 20 may preferably appear virtually on a display screen. Data screen 20 may be incorporated into wireless keyboards, thus increasing their versatility by allowing a user of such a keyboard to function at a greater distance from the monitor upon which the data is displayed. Examples of types of keyboards into which current data screen 20 may be incorporated include, inter alia, Qwerty, Dvorak, alphabetical, diagonally alphabetical, and random.

Current data screen 20 may be configured in many different ways. It may be fixed on the surface plane of the keyboard either in a flat or raised attitude, or it may be movable, tiltable, recessed, protruding, or in any other way adjustable to meet the requirements of users. Moreover, current data screen 20 may, with some size limitations, be configured to display more or less lines of typing comprising more or less characters per line. It will be appreciated that various embodiments will have different data quantity capacities. Moreover, a buffer memory may optionally be associated with current data screen 20.

Reference is now made to FIG. 3 which shows current data screen 20 removably attached to a preexisting keyboard 22, which is a conventionally hardwired keyboard which communicates with computer 13 via hardwire 19. A further embodiment of typing aid 10 provides for current data screen 20 to be configured as a separate apparatus which may be placed in close proximity to or upon keyboard 22 in order to facilitate the simultaneous viewing of keyboard 22 and the most recently typed data. Such a configuration allows typing aid 10 to serve as an aftermarket add-on to computing devices currently in use with an existing keyboard. Current data screen 20 is preferably attachable by means of mounting brackets, Velcro or adhesive attachment means or may be designed with a shape that allows it to mount upon or engage keyboard 22. It will be appreciated that different embodiments of current data screen 20 may be designed and configured for specifically identified keyboards.

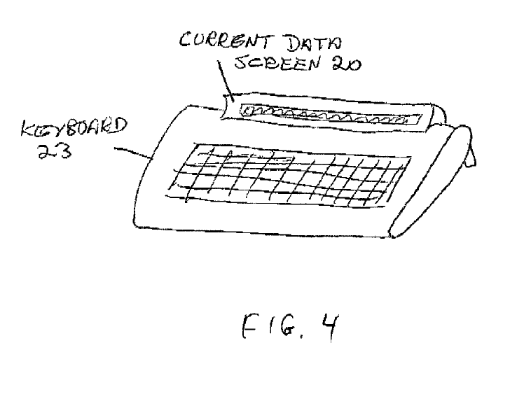

It is appreciated that current data screen 20 may be configured for any known keyboard. FIG. 4 depicts current data screen 20 in a further embodiment engaged upon keyboard 23 which is a wireless keyboard which communicates with computer 13 using wireless communication technology. Accordingly, current data screen 20 may be configured as required in order to communicate with a range of host keyboards so that characters keyed in thereon will be displayed on current data screen 20.

The method of this communication will vary according to different embodiments of typing aid 10. According to embodiments in which current data screen 20 is integral to keyboard 18 communication may preferably take place inside keyboard 18 with keyboard 18 internally wired to send the appropriate character stream to current data screen 20. Such an integrated embodiment may also be configured such that keyboard 18 and current data screen 20 communicate via computer 13, either by hardwire or by wireless communication. In such an embodiment, communication between keyboard 18 and computer 13 will preferably be bi-directional such that data may pass from keyboard 18 to computer 13 and from computer 13 to data screen 20. According to embodiments in which current data screen 20 is removably attachable to keyboard 22, current data screen 20 may be capable of communicating directly with computer 13. Such communication will preferably be uni-directional from keyboard 22 to computer 13 and also uni-directional from computer 13 to current data screen 20. Such communication may preferably take place in a number of different manners, including, but not limited to, the following:

1. A direct hard wire connection from keyboard 22 to current data screen 20.

2. A wireless connection from keyboard 22 to current data screen 20 based on wireless technologies such as IR (Infrared) or RF (radio frequency), or any other wireless communication means for example using the Blue Tooth protocol.

3. The existing hard wire connection from keyboard 22 to computer 13 with a splitter emanating from the hard wire connecting computer 13 to monitor 14 and connecting to current data screen 20.

4. The existing hard wire connection from keyboard 22 to computer 13 and a direct hard wire connection from computer 13, emanating from a communication port thereof (i.e. Serial, Parallel, SCSSI, Ethernet, Coax, PS/2, firewire, USB or IR) to current data screen 20.

5. The existing hard wire connection from keyboard 22 to computer 13 and a wireless connection from computer 13 to current data screen 20.

According to embodiments in which current data screen 20 is removably attachable to keyboard 23, communication may preferably take place via wireless connection from keyboard 23 to current data screen 20 based on wireless technologies such as IR (Infrared) or RF (radio frequency), or any other wireless communication means, for example using the Blue Tooth protocol.

In summary, communication between the components of typing aid 10, and further between typing aid 10 and a computing device with which it may be employed is subject to various implementations and may, in future embodiments, utilize newly developed communications technology.

The source of power supplied to current data screen 20 will vary according to the different embodiments, from being powered by its host computing device to being powered by its own independent power supply. In the case of the integral configuration, current data screen 20's power source will be the same as the keyboard's power source. In the case of the removably attachable configuration the power could be supplied either by the host computing device or by current data screen 20's self contained power supply. If the removably attachable configuration employs wireless communication between current data screen 20 and the computing device, then current data screen 20 will preferably have its own power source, since it cannot rely upon a hard wire connection with the computing device to convey power therefrom.

Current data screen 20 preferably employs any display technology currently available. In this respect, the display may be an LCD, LED or Organic LED display or any other display technology that may be known to the skilled person. The display on current data screen 20 may preferably be variable in many different respects such as color, size, contrast, etc. according to the technology available and the desires of the typist. It is appreciated that current data screen 20 may be configured to have a versatile display capability, comprising many components designed to provide maximum visibility from which a typist may select in order to facilitate typing productivity, such as colored text, variable brightness, bolded characters, adjustable size fonts, etc.

It is the object of the invention to offer the most useful and user friendly ergonomic configuration. Therefore, a range of current display alternatives are preferably provided, ranging from plain, unformatted alphanumerical data to formatted and colorized alphanumeric text resembling the text which appears on the display of external monitor 14,

According to one embodiment, current data screen 20 displays text in a user selected size, font, and formatting, independent of the size, font and formatting of the software application in use. According to this embodiment the display will have its own choice of fonts and settings from which the user may select. The embodiment requires limited logic and memory capabilities.

According to another embodiment current data screen 20 displays, to the extent possible, WYSIWYG (What You See Is What You Get) based on the display on external monitor 14. The objective is to provide the greatest consistancy between what the user sees on monitor 14 and what is seen on current data screen 20. To accomplish this, computer 13 sends to current data screen 20 both ASCII code containing the text and formatting code containing font, color, size, effects etc. Accordingly, this embodiment requires more involved logic and memory capabilities to properly display the WYSIWYG formatted text.

For this purpose, current data screen 20 preferably relies on the logic and memory capabilities of computer 13. This may be accomplished by installing a splitter connection so that data are sent to external monitor 14 from the serial port of computer 13 and in parallel from serial port to current data screen 20. Such a configuration utilizes the processor, video card functionality and serial port of computer 13, simply passing the information to current data screen 20 at the time the data are being sent to monitor 14. It can also be accomplished by sending the data from computer 13 to current data screen 20 through an alternate port, such as the USB port, with the necessary logic and memory capabilities built in to current data screen 20.

Typing aid 10 is not only useful for creating new documents, typing aid 10 is particularly versatile in its capacity to be applied to the document production capabilities of computer 13. In a typical configuration, computer 13 preferably supports a word processing application which permits text data stored in its memory to be brought to display screen 16 for editing. Typing aid 10 may be used to assist in this purpose.

Reference is now made to FIG. 5 which shows a soft wire application 26 which is supported by operating system 24 of computer 13. According to a preferred embodiment, typing aid 10 is supported by software installed in computer 13 which provides it with data selection capabilities allowing it to find and identify the data associated with a current data input position on screen 16. Such data is customarily located adjacent to the curser irrespective of where in a document the cursor is located. The cursor may be at the beginning, at the end or within a document. The cursor may move from one document to another document with software application 26 retaining the capability to find and identify the data associated therewith. Moreover, the cursor may move from one program to another, with software application 26 retaining the capability to find and identify the data associated therewith. Software application 26 allows typing aid 10 to select, perhaps according to an expressed user preference, the data associated with a current data input position and to display the data on current data screen 20. Such data may comprise file text preceding the cursor, following the cursor or on both sides of the cursor. Thus, references to a cursor include all of the above described modes of indicating a current data position.

Software application 26 also provides typing aid 10 with the capability to select and display on current data screen 20 data from other applications supported by computer 13, including newly received or downloaded data and data stored in the memory of computer 13. Such other applications may preferably comprise any programs which include the production or use of text data. In some programs, the data associated with a current data input position is not related to a cursor or is not located in proximity to a cursor. Rather, the data associated with a current data input position may be data associated with an active field displayed for data entry. Moreover, the data associated with a current data input position need not be entered via a keyboard, but may be entered by a mouse or other method of data entry unrelated to keyboard use. It is to be appreciated that software application 26 is capable of identifying the current data position, however it may be designated, and displaying data associated therewith however it may be entered, on current data screen 20.

Software application 26 preferably accesses operating system 24 to obtain from the operating system, the text from around the current data position, which it is then able to send to current data screen 20. The display functionality of operating system 24 is utilized and thus software application 26 works through the API or operating system programmers interface, with any application properly supported by operating system 24. Software application 26 preferably comprises a device driver application which loads on startup of operating system 24 and may also comprise a program which displays field and format data in the current data screen. In this case, the field name or designation will also be displayed in current data screen 20.

Moreover, in embodiments in which a multilanguage program is employed, program 26 is able to interrogate operating system 24 as to the currently enabled language, thereby to display the ASCII code accordingly.

Preferably, the software application, once loaded on startup of the operating system operates in the background constantly searching for the current data position in any program, including web browser programs, and upon finding the data position, sends the appropriate text to current data screen 20. In program interfaces where in addition to the cursor there is present a field name like “user name”, “password” “file name,”, “subject”, “address,” “location,”, etc., the typing aid will display the field name in addition to the text entered by the curser. Moreover, current data screen 20 may preferably display such data in one or more of a number of ways, such as scrolling, flashing, fading in and out, etc., as may be appropriate to the data or helpful to the user. In further utilization of this capability, further embodiments or typing aid 10 will preferably find many varied uses for current data screen 20 and this description contemplates such a varied and versatile capacity for use.

Software application 26 is preferably stored in an installable format on any or the many storage devices currently in use such as a CD or a 1.44 MB capacity disc or on any that may be devised in the future that possess the required capacity or in a downloadable format as could be downloaded from a communications network.

Software application 26 is preferably installed at the time of the installation of typing aid 10. Software application 26 is supportable by operating systems such as Windows, OS2, Unix, Linux, or Mac and therefore has wide applicability within currently operating computer configurations. It will be appreciated that in further embodiments typing aid 10 may preferably be a “plug & play” device, wherein operating system 24 has the driver information and other supporting software built-in, thus obviating the need for user installation of a software application.

In summary, the close proximity of current data screen 20 and its related keyboard addresses and solves most, if not all, of the disabilities faced by non-touch typists, such as:

1. Slowness caused by the time associated with uncertain typing because the absence of immediate feedback;

2. Inefficiency of error correction caused by the distance between keyboard and monitor. Because a user unknowingly commits an error and continues typing. The error is often several characters or words back in the latest addition to the text.

3. The time consuming nature of having to find the relevant, recently edited line of text indicated by the blinking cursor;

4. The ongoing physical demand of cocking the head up and down between keyboard and monitor

Therefore, the particular advantages of including typing aid 10 into the process of data entry on a personal computer directly address the above listed problems, as follows:

1. By viewing the results of her typing as she types without oscillating her head, the typist receives many of the benefits that the touch-typist experiences, such as simultaneous ongoing review including, for multi-lingual keyboards, ongoing indication of the language mode enabled, This will ease the burden/nuisance experienced by users of bi-lingual operating systems and programs. For example, users of Hebrew enables Windows with Hebrew/English Word will frequently confuse which language mode has been set and type for some time only to see gibberish thereafter.

2. Mistakes can be easily found and corrected immediately after they occur because they are immediately apparent on current data screen 20. This reduces the burden of repeated, extensive backspacing and backtracking the cursor to find and correct errors on a monitor containing a substantial amount of data.

It is appreciated that certain features of the invention, which are, for clarity described in the context of separate embodiments, may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited to that which has been particularly shown and described hereinabove. Rather, the scope of the present invention is defined by the appended claims and includes both combinations and subcombinations of the various features described hereinabove as well as variations and modifications thereof which would occur to persons skilled in the art upon reading the foregoing description. Accordingly, it is intended to embrace all such alternatives, modifications and variations that fall within the spirit and broad scope of the appended claims.

1. A typing aid for assisting with user data input to a computing device, said typing aid including a keyboard and a current data screen, associated with said keyboard, for location together in a single user field of view, the typing aid comprising functionality for interacting wide said computing device to display on said current data screen data associated with a current data input position, said current data input position including newly generated data input via said keyboard and data stored in a memory of said computing device, thereby enabling a user to simultaneously see said keyboard and said data associated with a current data input position.

2. The typing aid of claim 1, further comprising functionality for directly displaying, on said current data screen, newly generated data input via said keyboard, thereby enabling a user to simultaneously see said keyboard and said newly generated data input via said keyboard.

3. The typing aid of claim 1, further comprising functionality for editing said data associated with a current data position.

4. The typing aid of claim 1, wherein said current data screen is integral to said keyboard.

5. The typing aid of claim 1, wherein said current data screen is removably attachable to said keyboard.

6. The typing aid of claim 1, wherein said current data screen is an LCD screen.

7. The typing aid of claim 1, wherein said current data screen is powered from said computing device.

8. The typing aid of claim 1, wherein said current data screen is powered independently of said computing device.

9. The typing aid of claim 1, wherein said data associated with said current data input position is at least part of a text document.

10. The typing aid of claim 1, wherein said current data screen is capable of showing a single line of text.

11. The typing aid of claim 1, wherein said current data input position is indicated by the presence thereat of a cursor.

12. The typing aid of claim 1, wherein said data associated with said current data input position comprises the text preceding the cursor.

13. The typing aid of claim 12, wherein said data associated with said current data input position comprises the text following the cursor.

14. The typing aid of claim 12, wherein said data associated with said current data input position comprises text preceding the cursor and text following the cursor.

15. The typing aid of claim 12, wherein the cursor is at the beginning of a text document.

16. The typing aid of claim 12, wherein the cursor is at the end of a text document.

17. The typing aid of claim 12, wherein the cursor is substantially in the middle of a text document.

18. The typing aid of claim 12, wherein the cursor is capable of moving around within a text document thereby changing the display on said current data screen.

19. The typing aid of claim 12, wherein the cursor is capable of moving between different text documents thereby changing the display on said current data screen.

20. The typing aid of claim 12, wherein the cursor is capable of moving between different software applications thereby changing the display on said current data screen.

21. A typing aid consisting of a computing device capable of generating data, said computing device comprising a computer having a monitor, a keyboard connected thereto and a current data screen, associated with said keyboard or location together in a single user field of view, said computing device comprising functionality for displaying on said current data screen data associated with a current data input position, thereby enabling a user to simultaneously see said keyboard and said data associated with a current data input position

22. The typing aid of claim 21, wherein said computing device further comprises functionality for editing said data associated with a current data position.

23. The typing aid of claim 21, wherein said current data screen is integral to said keyboard.

24. The typing aid of claim 21, wherein said current data screen is removably attachable to said keyboard.

25. The typing aid of claim 1 wherein said current data screen is an LCD screen.

26. The typing aid of claim 21, wherein said current data screen is powered from said computer.

27. The typing aid of claim 21, wherein said current data input position includes newly generated data input via said keyboard and data retrieved from a memory of said computing device.

28. The typing aid of claim 21, wherein said data associated with said current data input position is a text document.

29. The typing aid of claim 21, wherein said current data screen is capable of showing a single line of text.

30. The typing aid of claim 21, wherein said current data input position is indicated by the presence thereat of a cursor.

31. The typing aid of claim 21, wherein said data associated with said current data input position comprises the text preceding the cursor.

32. The typing aid of claim 21, wherein said data associated with said current data input position comprises the text following the cursor.

33. The typing aid of claim 21, wherein said data associated with said current data input position comprises the text preceding the cursor and the text.

34. The typing aid of claim 30, wherein the cursor is at the beginning of a text document.

35. The typing aid of claim 30, wherein the cursor is at the end of a text document.

36. The typing aid of claim 30, wherein the cursor is in the middle of a text document.

37. The typing aid of claim 30, wherein the cursor is capable of moving around within text document thereby changing the display on said current data screen.

38. The typing aid of claim 30, wherein the cursor is capable of flowing between different text documents thereby changing the display on said current data screen.

39. The typing aid of claim 30, wherein the cursor is capable of moving between different software applications thereby changing the display on said current data screen.

40. A method of assisting with user data input to a computing device comprising the steps of
a. interrogating an operating system of said computing device regarding a location of a current data input position;
b. identifying from said interrogation, data associated with said current data input position, said data including at least one of newly generated data input via a keyboard and data stored in a memory of said computing device;
c. sending said identified data to an output associated with said keyboard; and
d. displaying said identified data on a current data screen, said current data screen associated with said keyboard for location together in a single user field of view such as to allow simultaneously viewing by a user of said current data screen and said keyboard.

41. The method of claim 40, wherein said current data screen is integral to said keyboard.

42. The method of claim 40, wherein said current data screen is removably attachable to said keyboard.

43. The method of claim 40, wherein sad current data screen is an LCD screen.

44. The method of claim 40, wherein said current data screen is powered from said computing device.

45. The method of claim 40, wherein said data associated with said current data input position is a text document.

46. The method of claim 40, wherein said current data screen is capable of showing a single line of text.

47. The typing aid of claim 40, wherein said current data input position is indicated by the presence thereat of a cursor.

48. The method of claim 40, wherein said data associated with said current data input position comprises the text preceding the cursor.

49. The method of claim 40, wherein said data associated with said current data input position comprise the text following the cursor.

50. The method of claim 40, wherein said data associated with said current data input position comprises the text preceding the cursor and the text following the cursor.

51. The method of claim 40, wherein the cursor is at the beginning of a text document.

52. The method of claim 47, wherein the cursor is at the end of a text document.

53. The method of claim 47, wherein the cursor is in the middle of a text document.

54. The method of claim 47, wherein the cursor is capable of moving around within a text document thereby changing the display on said current data screen.

55. The method of claim 47, wherein the cursor is capable of moving between different text documents thereby changing the display on said current data screen.

56. The typing aid of claim 47, wherein the cursor is capable of moving between different software applications thereby changing the display on said current data screen.
